(19) United States
(12) Patent Application Publication
(10) Pub. No.: US 2006/0158960 A1
(43) Pub. Date: Jul. 20, 2006

(54) Mixer paddle

(75) Inventor: Shuming Wu, Nanjing City (CN)

Correspondence Address: WALLENSTEIN WAGNER & ROCKEY, LTD, 311 SOUTH WACKER DRIVE, 53RD FLOOR, CHICAGO, IL, 60606, US

(73) Assignee: Nanjing Chervon Industry Co., Ltd.

(21) Appl. No.: 11/334,323

(22) Filed: Jan. 18, 2006

(30) Foreign Application Priority Data
Jan. 19, 2005 (CN) 200520068400.2

(51) Int. Cl. B01F 7/24

(52) U.S. Cl. 366/288; 366/320

(57) ABSTRACT

A mixer paddle for a mixer to mix particulate substances is provided including a main shaft for transferring rotation that acts thereon, at least one mixing shaft eccentric from the main shaft, and at least one paddle member mounted on the at least one mixing shaft and being freely rotatable thereabout. With such a structure, during the operation, the paddle member rotates around the main shaft and synchronously rotates around the mixing shaft due to the resistance produced by the particulate substances, so that power consumption is decreased, and mixing efficiency is improved.

### CROSS-REFERENCE TO RELATED APPLICATIONS

This application claims priority under 35 U.S.C. § 119 to Chinese Application No. 200520068400.2, filed on Jan. 19, 2005.

### FEDERALLY SPONSORED RESEARCH OR DEVELOPMENT

None.

### TECHNICAL FIELD

The invention relates to a mixer paddle for a power mixer.

### BACKGROUND OF THE INVENTION

A mixer generally includes a mixer paddle for mixing particulates. The mixer paddle conventionally comprises blades, a helical rod or paddles of other shapes fixed on a rotating shaft. U.S. Pat. No. 6,273,601 and No. 6,712,499 disclose such mixer paddles.

When a mixer is operated with a mixer paddle as mentioned hereinbefore, the particulates provide a high resistance to the rotation of the mixer paddle, increasing power consumption and resulting in low mixing efficiencies. Furthermore, particulate substances and liquid must be gradually added during the operation. Otherwise, the substance is very likely to lump and it becomes difficult to dissolve, diffuse and disintegrate into a mix.

The present invention is provided to solve the problems discussed above and other problems, and to provide advantages and aspects not provided by prior mixer paddles of this type. A full discussion of the features and advantages of the present invention is deferred to the following detailed description, which proceeds with reference to the accompanying drawings.

### SUMMARY OF THE INVENTION

Accordingly, it is an object of the present invention to provide an improved mixer paddle requiring less power, which achieves more efficient mixing.

To achieve the above-mentioned objective, the present invention provides a mixer paddle which includes a main shaft, at least one mixing shaft eccentric from the main shaft, at least one paddle member mounted on the mixing shaft and being freely rotatable thereabout, and a limiting member to prevent the paddle member from sliding out of the mixing shaft; wherein rotating of the main shaft drives the paddle and limiting members.

With such a structure, during the mixing process, the paddle member rotates around the main shaft and synchronously rotates around the mixing shaft due to the resistance produced by the particulate substances, so that power consumption is decreased and efficiency is improved.

Other features and advantages of the invention will be apparent from the following specification taken in conjunction with the following drawings.

### BRIEF DESCRIPTION OF THE DRAWINGS

The various embodiments according to the present invention will be further described in detail combined with the figures hereinafter.

FIG. 1 is a perspective view showing a mixer, its appended members, and a barrel, wherein the barrel is partly broken away so as to show the mixer paddle.

FIG. 2 is a perspective view of the mixer paddle in FIG. 1, wherein the rotating denotations are provided to show the moving state of each component.

FIG. 3 is an exploded view of the mixer paddle in FIG. 1.

FIG. 4 is a perspective view of a second embodiment of a mixer paddle according to the present invention.

FIG. 5 is a perspective view of a third embodiment of the mixer paddle according to the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

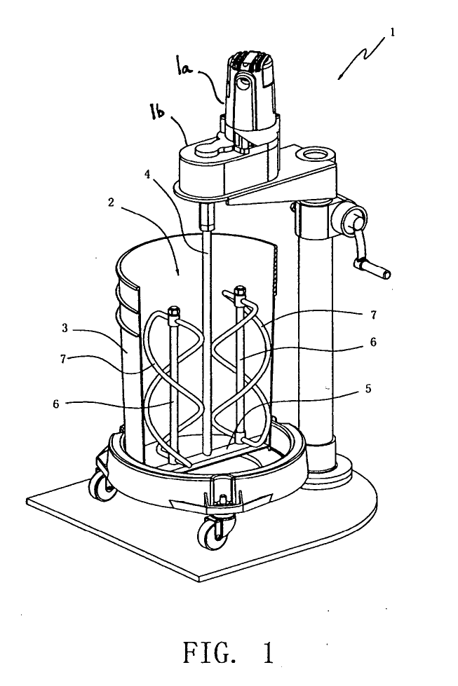

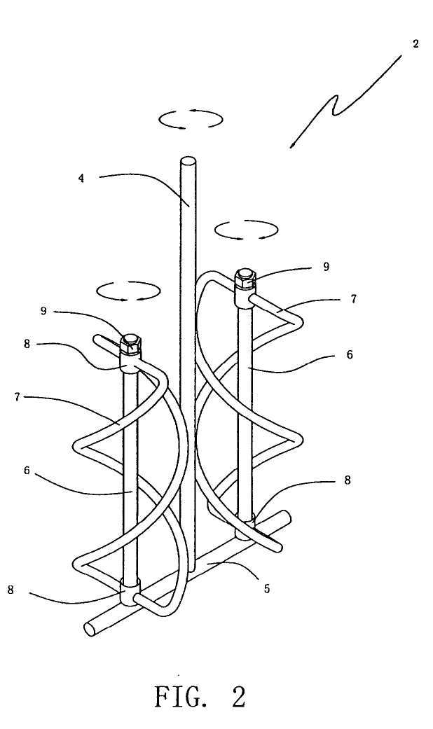

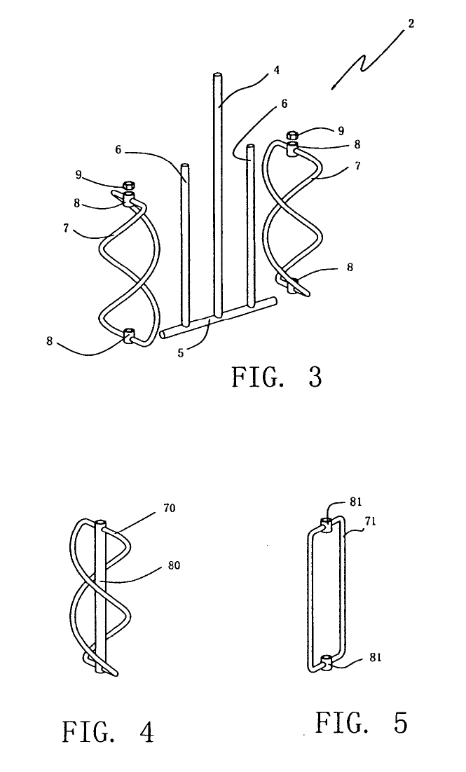

As shown in FIG. 1, a power mixer mainly comprises a power supply member 1 providing rotating power, a mixer paddle 2 and a barrel 3. The power supply member 1 generally includes a motor 1a connected to a drive unit 1b. Further referring to FIG. 2 and FIG. 3, the mixer paddle 2 includes a main shaft 4 which is operably connected to and driven by the power supply member 1. A rod 5 is transversely fixed on the bottom end of the main shaft 4. Two mixing shafts 6 are respectively disposed on opposing end portions of the rod 5. The mixing shafts 6 are preferably symmetrical and parallel to the main shaft 4, and have a circular cross section. The mixer paddle 2 also includes two helical paddle members 7 connected to the mixing shafts 6, respectively. Each paddle member 7 comprises two ferrules 8 (an upper and lower ferrule) with circular interior cavities. The ferrules 8 have such an inner diameter so that the paddle members 7 can freely rotate around the mixing shafts 6. Nuts 9 are disposed on the top ends of the mixing shafts 6 to prevent the paddle members 7 from sliding off.

Therefore, during operation, the power supply member 1 activates the main shaft 4 to rotate as indicated by the arrows in FIG. 2. Because the rod 5, and in turn the mixing shafts 6, are connected to the main shaft 4, they are driven to rotate when the power supply 1 rotates the main shaft 4. The paddle members 7 disposed on the mixing shafts 6 are also driven to rotate around the main shaft 4. Additionally, the paddle members 7 are also driven to rotate about their respective mixing shaft 6 by the force that is caused due to the resistance between the paddle members 7 and the particulate substance to be mixed. In this manner, the mixer paddle 2 of the present invention improves work efficiency when compared with prior mixer paddles, which include fixed mixing shafts or helical rods.

The present invention has been described above with reference to a preferred embodiment having two mixing shafts 6 spaced 180 degrees from one another (with the main shaft 4 spaced evenly between). It will be understood by those having ordinary skill in the art, however, that the mixer paddle 2 could take various configurations wherein a plurality of mixing shafts 6 are connected to the main shaft 4 and are evenly spaced thereabout. For example, to further improve efficiency, the mixer paddle 2 can include three or even four mixing shafts 6. In the embodiment having three mixing shafts 6 (not shown) the mixing shafts 6 preferably have an angle of approximately 120 degrees between them, while the embodiment having four mixing shafts 6 (also not shown) will preferably have an angle of approximately 90 degrees between the mixing shafts 6 with the main shaft 4 at the approximate center point. Therefore, depending on the substances to be mixed, one may increase mixing uniformity and efficiency as needed by increasing the number of mixing shafts 6 rotatably connected to the main shaft 4.

Other embodiments of paddle members 7 will be described by referring to FIG. 4 and FIG. 5. The paddle member 70 as shown in FIG. 4 includes an elongated tube or sleeve 80 having a cavity which permits the paddle member 70 to be slid over the mixing shaft 6 and prevents the particulate substances from flowing into the housing between the tube 80 and the mixing shaft 6. Accordingly, the paddle member 70 may rotate more smoothly around the mixing shaft 6. Besides the helical shape of the paddle member shown in FIGS. 1-4, the paddle member may take a number of different configurations. For example, the paddle member 71 can also be rectangular as shown in FIG. 5, or any other shape to ensure a uniform and efficient mixing of the desired substance.

The mixer paddle of the present invention is not limited to the embodiments as described in the specification and illustrated by the drawings. Without departing from the concept, modifications and variations of the present specification, numerous modifications come to mind without significantly departing from the spirit of the invention, and the scope of protection is only limited by the scope of the accompanying claims.

What is claimed is:

1. A mixer paddle comprising:
a main shaft, which can be operably connected to a power supply for rotating the main shaft;
a mixing shaft eccentric from the main shaft; and
a paddle member mounted on the mixing shaft and being rotatable thereabout.

2. The mixer paddle of claim 1, wherein the paddle member is helical-shaped.

3. The mixer paddle of claim 1, wherein the mixing shaft is approximately parallel to the main shaft.

4. The mixer paddle of claim 1, wherein the paddle member is provided with a tube having a cavity therethrough.

5. The mixer paddle of claim 1 further comprising a plurality of paddle members, each paddle member being mounted on a separate mixing shaft that is symmetrically distributed around the main shaft.

6. A mixer paddle comprising:
a main shaft connectable to a power supply for rotating the main shaft;
a plurality of mixing shafts connected to the main shaft, the mixing shafts spaced approximately equally around the main shaft; and,
a plurality of paddle members, each paddle member mounted on one of the plurality of mixing shafts and being rotatable about its respective mixing shaft.

7. The mixer paddle of claim 6 further comprising a rod transversely fixed to a bottom end of the main shaft.

8. The mixer paddle of claim 7, wherein the plurality of mixing shafts are connected to the main shaft via the transverse rod.

9. The mixer paddle of claim 6, wherein the plurality of mixing shafts are rotatable about the main shaft.

10. The mixer paddle of claim 6, wherein each paddle member includes an upper and lower ferrule having an inner cavity for receiving one of the plurality of mixing shafts.

11. The mixer paddle of claim 10, wherein the ferrules are configured to permit each paddle member to rotate about its respective mixing shaft.

12. The mixer paddle of claim 6, wherein each paddle member includes an elongated sleeve that receives one of the plurality of mixing shafts.

13. The mixer paddle of claim 6, wherein each of the mixing shafts form an angle with the main shaft.

14. The mixer paddle of claim 13, wherein each angle formed between the mixing shafts and the main shaft is approximately equal.

15. The mixer paddle of claim 14, wherein the angle is approximately 180 degrees.

16. The mixer paddle of claim 14, wherein the angle is approximately 120 degrees.

17. The mixer paddle of claim 14, wherein the angle is approximately 90 degrees.

18. A power mixer comprising:
a motor for rotating a drive unit;
a main shaft connected to the drive unit;
a mixing shaft connected to the main shaft, the mixing shaft being eccentric from, and parallel to, the main shaft; and
a paddle member connected to the mixing shaft and being rotatable about the mixing shaft.
